(19) United States
(12) Patent Application Publication
(10) Pub. No.: US 2009/0102590 A1
(43) Pub. Date: Apr. 23, 2009

(54) Underwater Electrically Insulated Connection

(75) Inventors: Mark Rhodes, West Lothian (GB); Brendan Hyland, Edinburgh (GB)

Correspondence Address: Goodwin Procter LLP;Attn: Patent Administrator, 135 Commonwealth Drive, Menlo Park, CA, 94025-1105, US

(73) Assignee: WIRELESS FIBRE SYSTEMS, Livingston (GB)

(21) Appl. No.: 12/278,458

(22) PCT Filed: Feb. 27, 2007
(86) PCT No.: PCT/GB2007/000676

§ 371 Date: Dec. 9, 2008

Related U.S. Application Data
(60) Provisional application No. 60/779,912, filed on Mar. 6, 2006.

(30) Foreign Application Priority Data
Feb. 28, 2006 (GB) 0603974.7

(51) Int. Cl. H01F 38/14; H01R 13/523; H02J 17/00; H01Q 1/04

(52) U.S. Cl. 336/107; 439/519; 343/788; 307/104

(57) ABSTRACT

An underwater connector (10) comprising a magnetic coupler for passing communications signals and/or power from one part (12) to another part (13) using magnetic coupling and without requiring direct electrically conductive contact between the parts (12, 13).

### INTRODUCTION

The present invention relates to a system for an underwater electrically insulated wet mating connection employing near field magnetic coupling to allow electronic information and power supply transfer between systems underwater.

### BACKGROUND

Many underwater systems require electrical signals to be carried between various parts and subsystems. These connections are often required to be removable or are between parts that move relative to one another. Waterproof connectors typically employ sealing techniques to exclude water from the region where dry electrical conductive contact is made. This makes it complex to build connections that can be made or broken while the system is immersed in water, especially under pressure at depth. Seals must allow movement or rotation of the parts. Any such system requires regular maintenance, including lubrication and replacement of the sealing parts. Both types of connection are complex and may be unreliable.

### SUMMARY OF INVENTION

According to one aspect of the present invention, there is provided an underwater electronic connector/joint that uses magnetic or electromagnetic (EM) coupling for conveying signals and/or power.

Using EM coupling avoids the need for direct electrical connection underwater. This is particularly beneficial for moving or rotating parts, where expensive and complex sealed joints would otherwise be needed.

Water may be present between the connector parts, so no sealing is required around the interface.

The two communicating systems are preferably held in mechanical contact to provide a fixed geometrical relationship between the electromagnetic transducers, but without requiring direct electrically conductive contact. Signal coupling loss can be reduced by winding coupling loops around a common high magnetic permeability core such as a ferrite material.

In an application where communication of data signals is required, but not power, the electromagnetic transducers need not necessarily be maintained in close contact. Some separation may be mechanically or operationally convenient, and still adequate. While separation provides poor magnetic coupling for transfer of significant power levels, data communication signals may still be transferred effectively.

Each part of the joint may consist of one or more magnetic loop antennas connected to transmit or receive sub systems. The signals for communication through the joint are passed to the transmit subsystems and fed out of the receive subsystem. The transmit and receive subsystems may be combined into transceiver subsystems for two-way transfer of signals.

The connector/joint may have two parts that may rotate relative to one another, especially where such movement or alternative mating orientations are mechanically convenient or advantageous. The rotatable joint can be implemented by providing symmetrical signal coupling about the axis of rotation. In systems where no mated rotation is required, the connectors may still be preferentially rotationally symmetrical so that no rotational alignment is required during mating.

One or more incoming signals may be modulated onto one or more carrier frequencies. This allows multiple signals to be passed over one joint while minimising interference between these signals. Employing multiple carrier frequencies also allows full simultaneous, two-way communication via the joint. Alternatively, a baseband signal (without carrier) may be adopted and coupled directly through the transducers.

The connector/joint systems may be used for both analogue and digital communications signals.

The connector may be used to transfer electrical power from one system to another without direct conductive contact.

Where both power and communications signals are being transferred via the connector, the power transfer AC signal is typically transmitted at a lower frequency than the modulated communications carrier frequency. In this way a high pass filter can protect the communications system from the high amplitude power carrier. Of course, other frequency separation arrangements could be adopted. As a further possible implementation, the power signal itself may be modulated and thereby also act simultaneously as a carrier for communications data.

According to another aspect of the invention, there is provided an underwater communication system comprising magnetic coupling means for passing signals and/or power from one part to another part without requiring direct electrical contact between the parts, wherein one part is a conductive cable and both parts are electrically insulated. Preferably, one part is adapted to substantially encircle the cable. Alternatively, one part may be substantially U-shaped.

According to yet another aspect of the invention, there is provided a method involving use of magnetic coupling in an underwater environment for passing signals between a cable and a coupling part without requiring direct electrical contact between the cable and the coupling part, wherein the cable and the said part are electrically insulated. Preferably, the coupling part is an electrically insulated clamp. Preferably, the coupling part includes a single or multi-turn coil.

### BRIEF DESCRIPTION OF DRAWINGS

Various aspects of the invention will now be described by way of example only and with reference to the accompanying drawings, of which:

FIG. 1 shows an underwater electronic signal transfer system employing magnetic coupling;

FIG. 2 is an example of the system of FIG. 1 in which high permeability magnetic cores are used;

FIG. 3 is an example of an alternative implementation of the system of FIG. 2 using a conical housing cross section to guide mating of the two-connector halves;

FIG. 4 is a circuit for use in the system of FIG. 1, the circuit forming a filter circuit around core coupling transformers;

FIG. 5 shows another underwater connector arrangement that uses magnetic coupling;

FIG. 6 is a schematic diagram of a modification to the connector of FIG. 5, and

FIG. 7 is a diagram illustrating a system that provides for a combination of power and communications signals via a single connector.

The present invention relates to a system for the transfer of electronic signals or other signals that may be represented in an electrical form and/or power between moving units without the need for direct electrically conductive contact. Signals are communicated via a joint by employing magnetic coupling to avoid the need for direct electrical contact. Preferably, the joint employs single or multi-turn magnetic loop antennas. Underwater, the use of magnetic coupling is beneficial as water is an electrically conductive medium, which results in significant attenuation of the electric field. Unprotected direct electrical connections are not functionally viable underwater due to the high conductivity of the water, which acts to short circuit the potential differences that define a digital signal, and because of corrosion of metal and other materials.

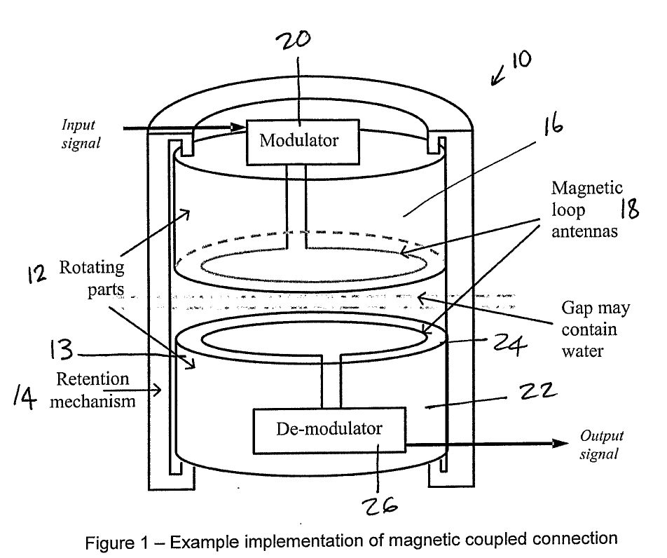

FIG. 1 shows a magnetic coupled connector/joint 10 for use underwater. This has two, physically separated, rotationally symmetrical parts 12, 13 that are retained within a cylindrical casing 14, thereby to form a non-contact connection. The casing 14 provides a degree of mechanical alignment, but may be omitted or replaced where other means maintain suitable relative positioning of the mating parts 12,13. Both parts 12,13 have housings that are constructed using a non-magnetic electrically insulating material, thereby to act as a barrier to the corrosive effects of salt water on metals. Preferably, the cylindrical casing 14 is releasable/removable, so that the rotatable parts 12,13 can be separated or removed, for example, for maintenance purposes. Within one part 12 is a transmitter system 16 that has an antenna 18 that is coupled to a modulator 20. This is operable to modulate signals that are to be transferred onto a carrier frequency prior to coupling into the antenna. Within the other part 13 of the connector is a receiver system 22. This has an antenna 24 that is coupled to a demodulator 26 for demodulating signals from the transmitter.

Both of the transmit and receive antennas 18 and 24 of FIG. 1 are single or multi-turn magnetic loop antennas, which act as magnetic dipoles. The two parts are held in mechanical contact using the cylindrical casing 14, to provide a fixed geometrical relationship between the electromagnetic transducers, but do not require direct electrically conductive contact. The distance between the two coils should be minimised to maximise the mutual flux coupling since coupling efficiency follows an inverse relationship with distance when coupled through a non-magnetic medium.

In use, energy from the antenna 18 of the transmitting system is coupled magnetically to the antenna 24 of the receiving system. This is beneficial as the water that is present around, and potentially inside, the joint 10 has minimal impact on a magnetic field whereas an electrical field would be rapidly attenuated. As the units are rotationally symmetrical they may rotate relative to one another freely.

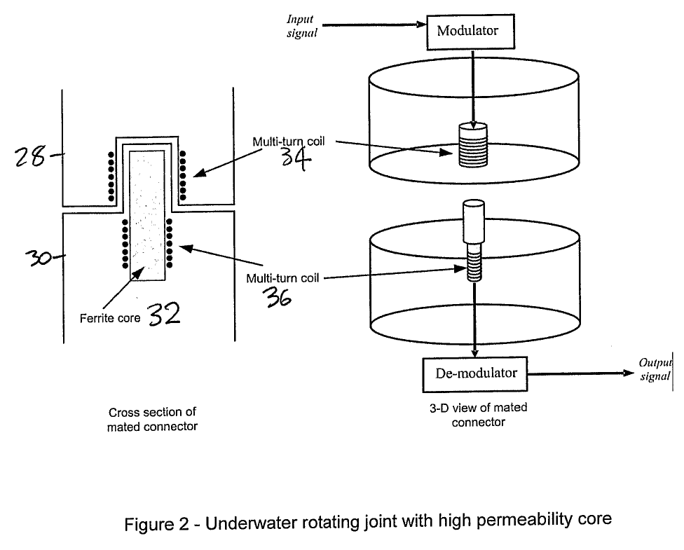

FIG. 2 shows another underwater non-contact connector configuration. As with FIG. 1, this has two relatively rotatable parts 28, 30 retained within a casing, one part being arranged for transmitting signals to the other part. To allow signal coupling between the parts, a high magnetic permeability material 32 is used. In this particular arrangement, each of the connector parts 28, 30 has a multi-turn coil 34, 36 at the joint/connector interface. For the transmitter part 28, a housing is formed round the coil in such a manner as to define a cavity within its interior. This transmitter housing 28 must be constructed using a non-magnetic electrically insulating material. The housing 28 must fully enclose the coil to achieve electrical isolation from the water and also act as a chemical barrier to the corrosive effects of salt water on metals.

Received within the cavity in the transmitter part 28 is a high permeability core 32 for magnetically coupling signals from the transmitter part 28 to the receiver part 30. This core 32 is within the receiver housing. As for the transmitter, this must be constructed using a non-magnetic electrically insulating material and must fully enclose the receiver coil 36 and in this case the core 32 to achieve electrical isolation from the water and act as a chemical barrier. The core 32 extends from the interior of the receiver coil 36 into the interior of the transmitter coil 34. In this way, signals from the transmitter can be magnetically coupled into the receiver.

By using a high permeability material for the core 32 of the arrangement of FIG. 2, the efficiency of the magnetic part of the coupling is enhanced. This is because the magnetic field is concentrated within the core 32 of the coupling loops. This material preferably has low electrical conductivity to minimise residual currents that lead to energy losses in the material. The material could for example be a ferrite. It should be noted that the gap between the two parts 28 and 30 is not a critical design parameter in this implementation since the ferrite core 32 acts to channel the magnetic flux from one coil to another. Separation may be varied within the movement allowed by the retention mechanism.

The magnetic coupling of the coils 34 and 26 may be increased still further by an enhancement (not shown) to the arrangement of FIG. 2, in which the reluctance of the closed magnetic path passing through the two coils is reduced further. Magnetic flux coupling the two coils will be increased advantageously if the magnetic circuit partially provided by the ferrite core through the coils is continued by further highly permeable material such as to close more effectively the magnetic circuit through the coils when they are brought into a mating position. Thus, two further structures of highly permeable material may be introduced, one formed around the outside of each coil, so that they come into close proximity when the parts are mated. Thus, as is desirable, the magnetic circuit will be completed in such a manner that the previously open section of the magnetic path largely of air, water or non-ferrous materials is replaced with a lower reluctance section of high permeability material. While often unnecessary for adequate data signal transfer, such an enhancement is important for effective transfer of significant power.

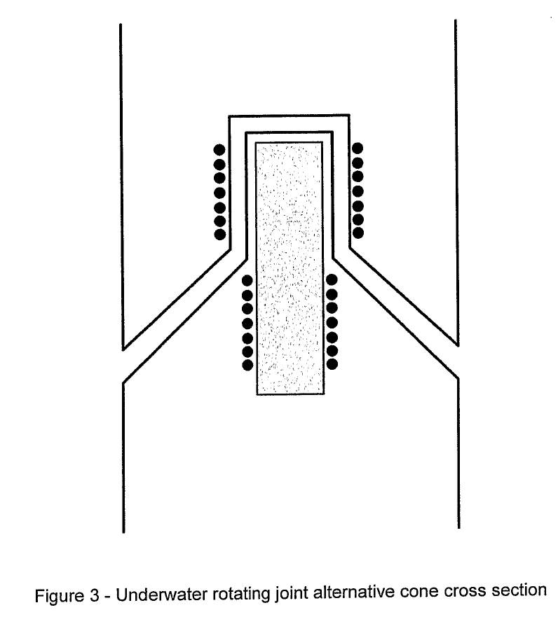

FIG. 3 shows an alternative mechanical arrangement for the joint of FIG. 2. In this case, the rotatable parts have housings that are shaped so as to facilitate connector mating. In particular, the parts have conical or tapered housings to mechanically guide final mating, so reducing the alignment accuracy required on initial approach.

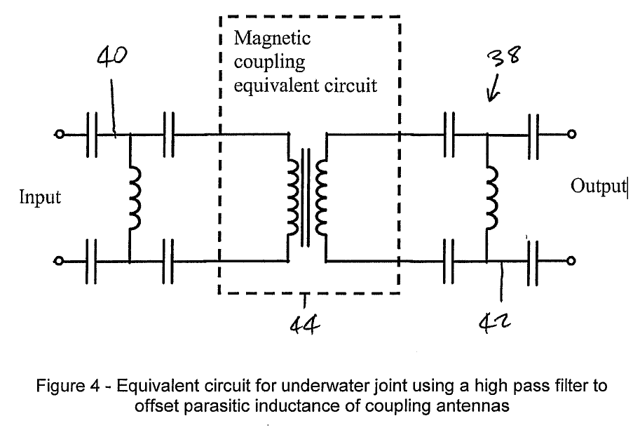

The coupling antennas of each of the connectors described above essentially form a transformer when the connector interfaces are brought into proximity. This may introduce parasitic inductance to the circuitry. When communications are to be passed through the connector, this presents an ac impedance to the communications signal and reduces efficiency. To limit the impact of this, a filter 38 can be used, as shown in FIG. 4. Here, the filter is an L-C filter 38 that comprises a first high pass portion 40 at the transmitter or input side and a second high pass portion 42 at the receiver or output side, the core of the filter being the transformer coupling 44. This effectively provides a balanced filter. Of course, it will be appreciated that any suitable filter could be used, such as a Butterworth high pass filter design, provided that the communicated signal is in the filter pass band. Such suitable filters or electrical network arrangements provide a useful compensation technique for transforming input and output impedances for optimum signal transfer.

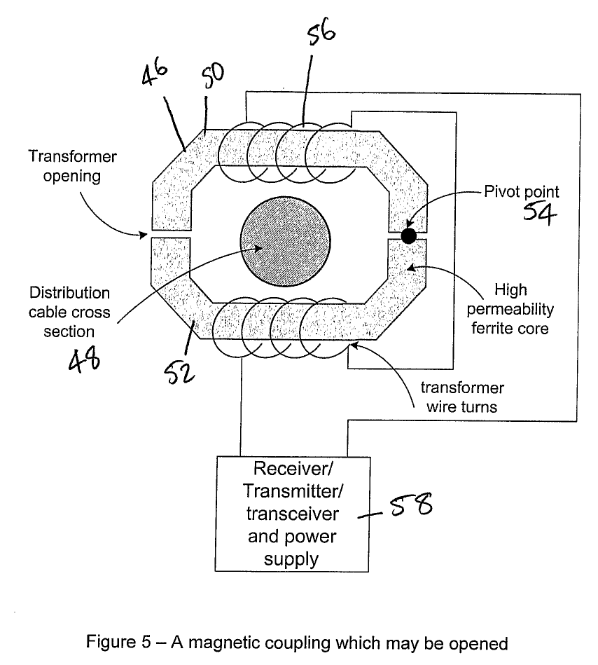

FIG. 5 shows yet another underwater non-contact connector, which allows non-contact connection to and communication with a distributed signal-carrying conductor at any point along its length. In this case, the connector comprises a clamp 46 that can be fitted round the conductor 48. The clamp 46 has two substantially semi-circular parts 50, 52 that are hinged 54 together, so that that they can be separated to allow the conductor to be positioned between them and then closed so that the conductor 48 is substantially enclosed within them. Each part of the clamp 50, 52 is made of a high magnetic permeability, low conductivity material, such as ferrite. To reduce eddy currents, the clamp parts 50, 52 may be formed from laminated sheets electrically insulated from each other. For underwater use, the clamp parts 50, 52 have to be coated in an electrically insulating material and a waterproof coating to prevent corrosion. The hinge mechanism 53 should be arranged to maintain low magnetic reluctance to flux between the two halves of the clamp to maximise signal coupling efficiency.

Wound round both parts of the clamp 50, 52 is a single, electrically insulated, waterproof cable 56. This forms multiple windings. The clamp core, windings and current carrying conductor act as a transformer, in which the core 50, 52 and conductor 48 act as a single turn primary winding and the core 50, 52 and the windings 56 act as the secondary transformer winding. Connected to the ends of the secondary winding is a transmitter/receiver/transceiver 58 and power supply arrangement for allowing communications signals and/or power to pass to and from the conductor using magnetic coupling. This can be done at any point along the cable, merely by re-positioning the clamp.

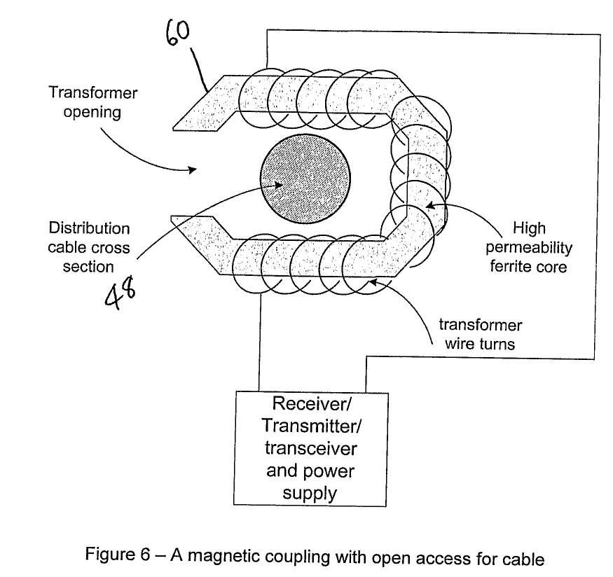

FIG. 6 shows a modified version of the arrangement of FIG. 5. In this case, the clamp has a substantially U-shaped core/clamp portion 60 that can be readily positioned round the signal or power carrying cable 48. This has no moving parts so is more robust than the clamp of FIG. 5. However, it may be less efficient since it does not totally enclose the surrounding the cable with a low reluctance path for magnetic flux.

To facilitate transformer coupling in the arrangements of FIGS. 5 and 6, the cable 48 must be carrying an AC signal. In practice, AC signals are often carried by a two-conductor system. In this case, the transformer core must enclose only one conductor 48 otherwise the opposing instantaneous current directions in the two conductors will result in zero net magnetic field. In one implementation the two conductors could be enclosed in separate sleeves so the clamping transformer can enclose only one conductor. In another implementation, the water can be employed as a ground return path for AC power signals that can then be carried by a single conducting cable.

Optionally or additionally the systems described above can be used for the transfer of power. Where both power and communication signals are to be transmitted, the power transfer AC signal will typically be transmitted at a lower frequency than the modulated communications carrier frequency. In this way, a high pass filter can protect the communications system from the high amplitude power carrier.

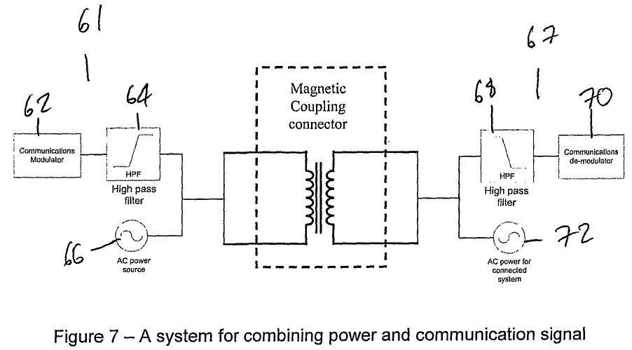

FIG. 7 shows an arrangement for handling dual signal/power transmission. This can be used with any of the connectors described above with reference to FIGS. 1 to 6. At the transmitter side 61, there is provided a communications modulator 62 for modulating a communications data signal onto a carrier signal of some frequency higher than that of the power. The modulator 62 is connected to the magnetic connector via a high pass filter 64. Also connected to the transmit side of the connector is an AC power source 66. AC power from the source 66 is transmitted at a lower frequency than the modulated communications carrier frequency output from the modulator 62. The high pass filter 64 is selected to prevent leakage of AC current from the power supply 66 into the communications modulator 62, whilst at the same time allowing signals to be passed from the communications modulator 62 over the connector to the receiver. Typically, power and communications signals are transmitted simultaneously, although they are separated in frequency. At the receiver side 67, a high pass filter 68 is connected between the magnetic connector and a communications demodulator 70. This filter 68 is selected to allow communications signals to pass through to the demodulator 70, but prevent high power AC current from passing into the communications system. Power transmitted from the transmitter side 61 of the connector is captured by an AC circuit 72 at the receiver 67 and used as necessary.

Although some of the embodiments of the invention utilise power and data communications frequencies that are deliberately separated for convenience of implementation, it will be appreciated that the alternating power signal itself may be used as a carrier for data communications information instead of a separate carrier. For this purpose it is necessary to modulate the power signal source with the data, typically by one of the well-known methods of frequency or phase modulation, at one side of the coupler and demodulate the data at the other side. In another embodiment a data communication signal may be transmitted across the coupling in the opposite direction from the power. In a further embodiment, transmission of data in both directions may be achieved, either simultaneously or sequentially. This can be done by, for example, using more than one carrier.

A skilled person will appreciate that variations of the disclosed arrangements are possible without departing from the invention. For example, although the specific implementations are described separately, it will be appreciated that there are many alternative configurations. In addition, whilst FIGS. 5 and 6 show clamps that are not continuous, use of a continuous clamp, for example a ferrite toroid would provide a circular unbroken magnetic flux path, thereby improving performance. However, this mechanical arrangement would require passing the conductor through the toroid and so for some applications may be less desirable. The single turn primary “winding” limits the amount of power that can be coupled using a single clamp. Equally, although FIGS. 5 and 6 show only a single clamp, it will be appreciated that multiple clamps could be used in parallel.

Also, whilst the systems and methods described are generally applicable to seawater, fresh water and any brackish composition in between, because relatively pure fresh water environments exhibit different electromagnetic propagation properties from saline seawater, it will be appreciated that different operating conditions may be needed in different environments. Optimisation required for specific saline constitutions will be obvious to a practitioner skilled in this area. Accordingly the above description of the specific embodiment is made by way of example only and not for the purposes of limitation. It will be clear to the skilled person that minor modifications may be made without significant changes to the operation described.

1. An underwater connector comprising a magnetic coupler for passing communications/data signals and/or power from one part to another part using magnetic coupling without requiring direct electrically conductive contact between the parts.

2. An underwater connector as claimed in claim 1 wherein the magnetic coupler comprises a magnetically coupled loop antenna.

3. An underwater connector as claimed in claim 1 or claim 2 that is configured to use one or more carrier frequencies to carry one or more independent signals.

4. An underwater connector as claimed in any of the preceding claims, wherein the connector parts are movable relative to one another.

5. An underwater connector as claimed in claim 4 wherein the connector parts are rotatable relative to one another.

6. An underwater connector as claimed in claimed in any of the preceding claims wherein the magnetic coupler includes a high magnetic permeability material, such as ferrite.

7. An underwater connector as claimed in claimed in any of the preceding claims wherein at least one part of the connector has a transmitter for causing signals to be transmitted via the magnetic coupler.

8. An underwater connector as claimed in claimed in any of the preceding claims wherein at least one part of the connector has a receiver for receiving signals via the magnetic coupler.

9. An underwater connector as claimed in any of the preceding claims further comprising restraining means for restraining movement of the connector parts.

10. An underwater connector as claimed in claim 9 wherein the restraining means are releasable or removable.

11. An underwater connector as claimed in any of the preceding claims comprising a filter.

12. An underwater connector as claimed in claim 11 wherein the filter is a bandpass filter.

13. An underwater connector as claimed in any of the preceding claims wherein the parts are rotationally symmetric.

14. An underwater connector as claimed in any of the preceding claims adapted to transmit power and communication/data signals, preferably in the form of power carrying and communication/data carrying waveforms.

15. An underwater connector as claimed in claim 14 wherein the power carrying and signal carrying waveforms are separated.

16. An underwater connector as claimed in claim 15 wherein the power carrying and signal carrying waveforms are separated in frequency.

17. An underwater connector as claimed in claim 16 wherein one or more frequency dependent filters are provided to prevent the power carrying waveform from impinging on transmit/receiver circuitry for the signal carrying waveform.

18. An underwater connector as claimed in claim 14 or claim 15 wherein the data/communications signal is modulated on the power.

19. An underwater connector as claimed in any of claims 14 to 18 wherein the data/communication signal and power are transmitted in opposite directions.

20. An underwater connector as claimed in any of the preceding claims adapted to transmit data/communication signals in two directions.

21. An underwater connector as claimed in any of the preceding claims including a transmitter that includes a modulator and a receiver that includes a demodulator.

22. An underwater connector as claimed in any of the preceding claims wherein one part is a conductive cable.

23. An underwater connector as claimed in claim 22 wherein the other part is adapted to substantially encircle the cable.

24. An underwater connector as claimed in claim 22 wherein the other part is substantially U-shaped.

25. Use of magnetic coupling in an underwater environment for passing signals and/or power one part and another part without requiring direct electrical contact between the parts.

26. Use of magnetic coupling as claimed in claim 24 wherein one part is an electrical cable and the other part is an electrically insulated clamp.
